(19) United States
(12) Patent Application Publication
(10) Pub. No.: US 2009/0197044 A1
(43) Pub. Date: Aug. 6, 2009

(54) Absorptive Heat Shield

(75) Inventors: Marc Pelzer, Baar (CH); Stefan Janzen, Wetter (DE)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: PELZER ACOUSTIC PRODUCTS, LLC, Thomson, GA (US)

(21) Appl. No.: 12/025,407

(22) Filed: Feb. 4, 2008

(51) Int. Cl. B32B 3/24; B32B 38/04; B32B 38/06; B32B 38/00

(52) U.S. Cl. 428/138; 156/252; 156/219; 156/245

(57) ABSTRACT

A sound absorbing heat shielding material includes an inner heat reflective layer, a sound absorbing layer and an outer layer. The inner heat reflective layer defines a plurality of openings therethrough in which the openings are configured to impart a high air flow resistivity on the inner heat reflective layer. The sound absorbing layer is disposed next to the heat reflective layer. The outer layer is disposed adjacent to the sound absorbing layer and opposite from the inner heat reflective layer. The outer layer defines a plurality of openings that allow air to pass therethrough.

### BACKGROUND OF THE INVENTION

1. Field of the Invention

The present invention relates to a heat shield and, more specifically, to a heat shield having sound absorptive qualities.

2. Description of the Prior Art

Heat shields are used in many mechanical applications to protect one part of a mechanism from heat radiating from another part of the mechanism. For example, in automotive applications, heat shields are used to protect a vehicle cabin from the engine compartment and the exhaust assembly. Heat shields are also effective in maintaining the temperature of an engine compartment, thereby reducing the energy wasted as a result of restarting an engine that has recently been turned off. Existing heat shields typically include one or more layers of reflective foil, sometimes sandwiched about a heat insulating layer such as glass wool or foam.

Many engine components generate substantial amounts of noise. Unfortunately, most heat shielding materials reflect most of the sound generated by a noisy component, as they have low sound absorption properties.

Typical sound absorbing heat shields use an outer impermeable metallic shell with an absorptive layer on the inside. The absorption layer is then covered with a support material, such as a metallic wire mesh. In another type of heat shield uses one or several layers of a micro-perforated metallic foil, which are applied adjacent to a panel, such as a floor panel of a vehicle. These solutions usually provide an absorptive surface towards the exhaust pipe or muffler. However, they are typically applied to the upper side of the heat and noise source, but are open towards the lower side, usually the road surface under the vehicle. Thus, they provide a partial encapsulation only and are not appropriate for high heat and noise insulation applications.

Other solutions are used to encapsulate high temperature and high noise radiating areas completely and are typically designed as a sandwich material with two or more impermeable metallic layers with either empty air gaps or the space between the metallic layers filled with absorption materials—typically inorganic glass or mineral fibers or other devices just to create a distance piece between the two outer shells. In order to increase three dimensional formability these metal sheets are often corrugated or embossed in different geometries.

One approach to making a sound absorbing heat shield includes placing a sheet of heat-reflecting material that includes bores with a relatively large diameter (i.e., about 1 mm to 7 mm) against a layer of a sound insulating material. A solid sheet is place against the other side of the sound insulating layer. One disadvantage of this approach is that because the bores are relatively large, the heat-reflecting sheet has a very low air flow resistivity and, therefore, does little to attenuate sound. Also, the solid sheet backing reflects sound.

With existing approaches, encapsulating a noise source leads to an increase of the sound pressure level (SPL) inside the encapsulation. To minimize this SPL increase absorption material has to be applied to the inner walls of the encapsulation. This leads to an SPL reduction and hence to a much higher noise reduction of the noise encapsulation. In order to optimize the noise reduction further, the encapsulation has to be substantially air-tight. Any leakage reduces the noise reduction effect of the encapsulation substantially. On the other hand, the temperature of a heat radiating source (e.g., exhaust manifold, turbo charger, catalytic converter, etc.) inside an air-tight encapsulation can rise to an undesired level.

Therefore, there is a need for a heat shield that is effective at both absorbing noise and shielding against heat transmission.

Therefore, there is a need for a noise absorbing heat shield that does not cause the temperature inside an encapsulation to rise to an undesired level.

### SUMMARY OF THE INVENTION

The disadvantages of the prior art are overcome by the present invention which, in one aspect, is a sound absorbing heat shielding material that includes an inner heat reflective layer, a sound absorbing layer and an outer layer. The inner heat reflective layer defines a plurality of openings therethrough in which the openings are configured to impart a high air flow resistivity on the inner heat reflective layer. The sound absorbing layer is disposed next to the heat reflective layer. The outer layer is disposed adjacent to the sound absorbing layer and opposite from the inner heat reflective layer. The outer layer defines a plurality of openings that allow air to pass therethrough.

In another aspect, the invention is a sound absorbing heat shield for providing thermal and acoustic insulation to a noisy heat radiating body. An inner heat reflective foil layer that defines a plurality of micro-perforations therethrough and is spaced apart from the heat radiating body. A sound absorbing layer is disposed next to the heat reflective layer. An outer layer is disposed adjacent to the sound absorbing layer and opposite from the inner heat reflective layer. The outer layer defines a plurality of micro-perforations.

In yet another aspect, the invention is a method of making a sound absorbing heat shield, in which an inner layer of heat reflective sheet material is perforated. An outer layer of sheet material is perforated. A layer of sound absorbing material is sandwiched between the inner layer and the outer layer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a cross-sectional view of one embodiment of a sound absorbing heat shielding material.

FIG. 2 is a cross-sectional view of one embodiment of a sound absorbing heat shield.

FIG. 3A is a schematic diagram demonstrating one method of making perforated and embossed foil.

FIG. 3B is a schematic diagram demonstrating a second method of making perforated and embossed foil.

FIGS. 4A-4C are schematic diagrams demonstrating the forming of sound absorbing heat shielding material into a sound absorbing heat shield.

FIGS. 5A-5D are photographs of embossed and micro-perforated foil.

FIG. 6 is a photograph of one embodiment of a sound absorbing heat shield.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

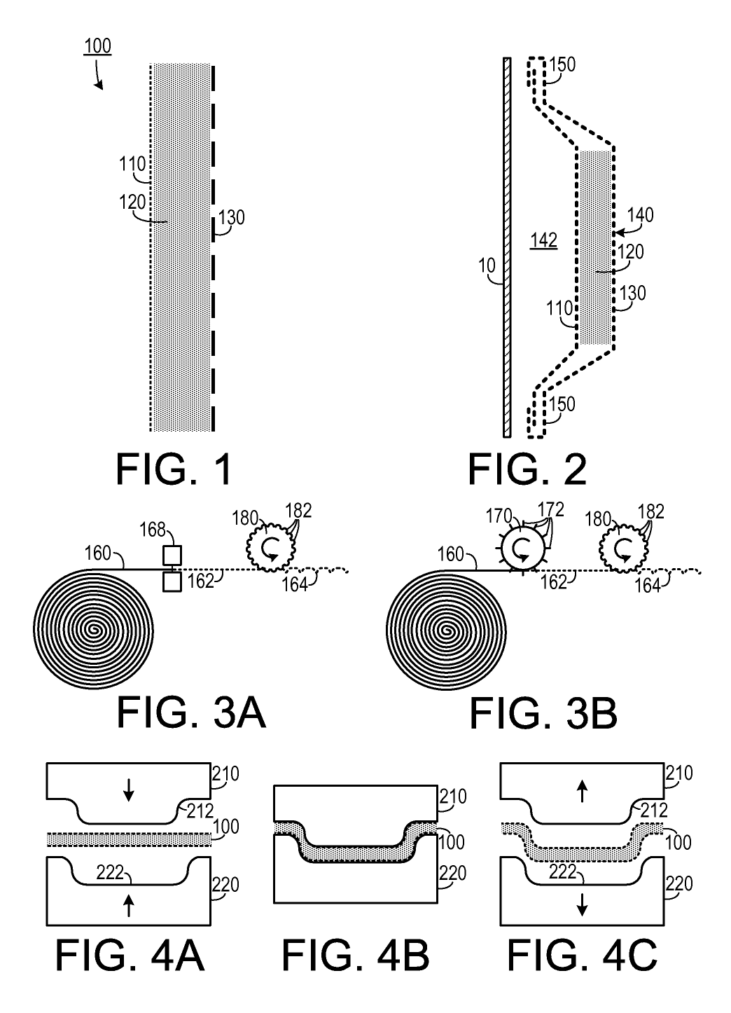

As shown in FIG. 1, one embodiment of a sound absorbing heat shield material 100 includes an inner heat reflective layer 110 that defines a plurality of openings therethrough in which the openings are configured to impart a high air flow resistivity on the inner heat reflective layer. A sound absorbing layer 120 is placed next to the heat reflective layer 110. An outer layer 130 is placed adjacent to the sound absorbing layer 120 and opposite from the inner heat reflective layer 110. The outer layer 130 defines a plurality of openings that allow air to pass therethrough.

The inner layer 110 typically includes a micro-perforated metallic or inorganic embossed foil material, such as aluminum, steel or stainless steel. The typical thickness of the inner layer 110 is between 0.05 mm to 5 mm with a thickness between 0.1 to 0.3 mm being preferred. The typical open area due to the micro-perforations is from 0.25% to 10%, with 0.5% to 5% being preferred. Typically, the openings are micro-perforations (holes having a diameter in the range of 0.1 mm to 2 mm, with a diameter of 0.2 mm to 0.5 mm being preferred). Micro-perforations increase air flow resistivity because the ratio of length to diameter of the perforations is relatively high, which results in air molecules to imparting increased energy onto the interior walls of the perforations as the air molecules pass therethrough.

The sound absorbing layer 120 can be made from such materials as, for example, metallic fiber, glass fiber, mineral fiber, and melamine foam. Typically, the sound absorbing layer 120 has an air flow resistivity in a range from 20 kPa*s/m² to 1000 kPa*s/m², with 200 kPa*s/m² to 500 kPa*s/m² being preferred.

The outer layer 130 may also include a material that has a high air flow resistivity, such as a micro-perforated foil. The outer layer 130 can include micro-perforated metallic or inorganic embossed foil material, such as aluminum, steel or stainless steel. A typical thickness of the outer layer 130 is between 0.05 mm to 5 mm, with 0.1 mm to 0.3 mm being preferred. The micro-perforation includes holes having a typical hole diameter between 0.1 mm to 2 mm, with 0.2 mm to 0.5 mm being preferred. The typical open area due to the micro-perforations is from 0.25% to 10%, with 0.5% to 5% being preferred.

In one embodiment, the inner heat reflective layer 120 will include a plurality of embossments. The outer layer 130 may also include embossments. The embossments increase the foil stiffness and facilitate forming of the heat shield material 100 into three dimensional shapes by preventing excessive strain on the materials used in the layers during forming.

The outer layer 130 properties do not necessarily need to be the same as for the inner layer 110. In certain circumstances the open area can vary and in certain applications, the outer layer 130 can even be partially or completely impermeable to avoid liquids to penetrate through the micro-perforations into the absorption material. In other applications different absorption properties to the inside and the outside can be beneficial.

The foil and absorber materials used in the heat shielding materials described above are selected to correspond to the operational temperature range for each application. For example, for a heat shielding material designed to operate at a very high temperature range (such as between 750° C. and 1000° C.), stainless steel in an austenitic structure for the inner layer 110 with a mineral fiber sound absorbing layer 120 could typically be used. For a heat shielding material designed to operate at a temperature in the range between 500° C. and 750° C., a steel inner layer 110 in combination with a glass fiber sound absorbing layer 120 could be used. For operating temperatures below 500° C., an aluminum inner layer 110 and a glass fiber sound absorbing layer 120 could be used. For applications designed to operate below 250° C., organic foam or fiber materials can used as for the sound absorbing layer 120.

As shown in FIG. 2, one embodiment of a sound absorbing heat shield 140 for providing thermal and acoustic insulation to a noisy heat radiating body 10 includes sound absorbing heat shield material described above formed so as to define an air gap 142 between the noisy heat radiating body 10 and the inner heat reflective foil layer 110. Typically the air gap 142 will have a thickness around 2 mm to 50 mm. Tabs 150 at the ends of the material may be folded over to add strength to attachment points for attaching the heat shield 140 to the body being protected.

One method of making a perforated and embossed foil 160 is shown in FIG. 3A. A flat sheet of foil 160 is passed under a needle felt machine 168 (e.g., as disclosed in U.S. Pat. No. 4,241,479, issued to Dilo, the entirety of which is incorporated herein by reference). The needle felt machine 168 is configured to punch a predetermined configuration of micro-perforations into the foil, thereby generating a perforated foil 162. The perforated foil 162 passes under an embossing calendar roll 180 that includes a desired texture 182 on its outer surface. The result is an embossed and perforated foil 164. A second method of making a perforated and embossed foil 160 is shown in FIG. 3B, in which the flat sheet of foil 160 is passed under a needle roller 170, which is essentially a roller that has a plurality of needles 172 extending therefrom. The spacing and diameter of the needles 172 determines the density and diameter of the perforations in the resulting perforated foil 162.

A heat shield may be made, as shown in FIGS. 4A-4C, by placing heat shield material 100 between two forms 210 that are complementary in shape to the preselected shape of the heat shield and 220, as shown in FIG. 4A, and then pressing the forms 210 and 220 together, as shown in FIG. 4B. Once forms 210 and 220 are separated, as shown in FIG. 4C, the heat shield material 100 has the preselected shape.

Photographs of several examples of embossed foil are shown in FIGS. 5A-5D. A non-perforated foil 310 is shown in FIG. 5A; an embossed perforated foil 312 with 1% open area is shown in FIG. 5B; an embossed perforated foil 314 with 2% open area is shown in FIG. 5C; and An embossed perforated foil 316 with 5% open area is shown in FIG. 5D. A photograph of one example of a heat shield 320 made according to the above disclosure is shown in FIG. 6.

One embodiment of the invention prevents an unnecessary temperature increase. For most sound reduction applications, a noise reduction in the order of magnitude of 10 to 20 dB is sufficient. In case of an encapsulation with sufficient air gaps at the edges, in order to minimize temperature rise, heat shields according to the invention are less sensitive to this effect because both the inner layer 110 and the outer layer 130 are air permeable. This leads to a lower SPL increase inside the encapsulation and has the added benefit that noise can be absorbed in the vicinity of the encapsulation.

Another advantage of the invention is to increase the absorption properties not to the inside only but also around the encapsulation (e.g., inside the surrounding engine compartment). This additional absorption on the outside of the encapsulation is especially beneficial for encapsulation applications inside larger cavities such as engine rooms, etc. with other noise sources (e.g., turbo charger, injection pumps, alternator, etc.) in close proximity to the encapsulated source.

The invention gives the designer the freedom to tune the sound transmission loss (STL) and absorption properties to a desired value. More absorption or more STL can be chosen simply by changing the number of micro-perforations in the two outer layers and by changing the thickness and air flow resistivity (AFR) of the intermediate absorber layer.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A sound absorbing heat shielding material, comprising:
a. an inner heat reflective layer that defines a plurality of openings therethrough in which the openings are configured to impart a high air flow resistivity on the inner heat reflective layer;
b. a sound absorbing layer disposed next to the heat reflective layer; and
c. an outer layer disposed adjacent to the sound absorbing layer and opposite from the inner heat reflective layer, the outer layer defining a plurality of openings that allow air to pass therethrough.

2. The sound absorbing heat shielding material of claim 1, wherein the inner heat reflective layer comprises a micro-perforated sheet material.

3. The sound absorbing heat shielding material of claim 2, wherein the micro-perforated sheet material comprises a metal foil.

4. The sound absorbing heat shielding material of claim 3, wherein the metal foil comprises a material selected from a group consisting of: aluminum foil, steel foil and stainless steel foil.

5. The sound absorbing heat shielding material of claim 1, wherein the sound absorbing layer comprises a material selected from a group consisting of: metallic fiber, glass fiber, mineral fiber, melamine foam, and combinations thereof.

6. The sound absorbing heat shielding material of claim 1, wherein the sound absorbing layer comprises a material having an air flow resistivity in a range from 20 kPa*s/m² to 1000 kPa*s/m².

7. The sound absorbing heat shielding material of claim 6, wherein the sound absorbing layer comprises a material having an air flow resistivity in a range from 200 kPa*s/m² to 500 kPa*s/m².

8. The sound absorbing heat shielding material of claim 1, wherein the outer layer comprises a material with high air flow resistivity.

9. The sound absorbing heat shielding material of claim 8, wherein the outer layer comprises a micro-perforated foil.

10. A sound absorbing heat shield for providing thermal and acoustic insulation to a noisy heat radiating body, comprising:
a. an inner heat reflective foil layer that defines a plurality of micro-perforations therethrough, the inner heat reflective foil layer spaced apart from the heat radiating body;
b. a sound absorbing layer disposed next to the heat reflective layer; and
c. an outer layer disposed adjacent to the sound absorbing layer and opposite from the inner heat reflective layer, the outer layer defining a plurality of micro-perforations.

11. The sound absorbing heat shield of claim 10, wherein the inner heat reflective foil layer, the sound absorbing layer and the outer layer have a shape so as to define an air gap between the inner heat reflective foil layer and the noisy heat radiating body.

12. The sound absorbing heat shield of claim 11, wherein the air gap has a thickness of from 2 mm to 50 mm.

13. The sound absorbing heat shield of claim 11, wherein the inner heat reflective foil layer comprises a material selected from a group consisting of: aluminum foil, steel foil and stainless steel foil.

14. The sound absorbing heat shield of claim 11, wherein the inner heat reflective foil layer comprises a plurality of embossments.

15. The sound absorbing heat shield of claim 11, wherein the inner heat reflective foil layer has a thickness in a range from 0.05 mm to 5.0 mm.

16. The sound absorbing heat shield of claim 11, wherein the sound absorbing layer comprises a material selected from a group consisting of: metallic fiber, glass fiber, mineral fiber, melamine foam, and combinations thereof.

17. A method of making a sound absorbing heat shield, comprising the actions of:
a. perforating an inner layer of heat reflective sheet material;
b. perforating an outer layer of sheet material;
c. sandwiching a layer of sound absorbing material between the inner layer and the outer layer.

18. The method of claim 17, further comprising the action of embossing at least one of the inner layer and the outer layer.

19. The method of claim 18, further comprising the action of forming the inner layer, the outer layer and the sound absorbing material into a preselected shape.

20. The method of claim 19, wherein the forming action comprises the actions of:
a. placing the inner layer, the outer layer and the sound absorbing material between two forms that each have a shape complimentary to the preselected shape; and
b. pressing the two forms together, thereby driving the inner layer, the outer layer and the sound absorbing material into the preselected shape.
